(19) United States
(12) Patent Application Publication
(10) Pub. No.: US 2026/0297218 A1
(43) Pub. Date: Oct. 1, 2026

(54) HEMICELLULOSE EXTRACTION PROCESS

(71) Applicant: Abu Dhabi University, Abu Dhabi (AE)

(72) Inventors: Ahmed Al-Harrasi, Nizwa (OM); Talha Shireen Khan, Nizwa (OM); Yasir Abbas Shah, Nizwa (OM); Saurabh Bhatia, Nizwa (OM); Dinu Thomas Thekkuden, Abu Dhabi (AE)

(73) Assignee: Abu Dhabi University, Abu Dhabi (AE)

(21) Appl. No.: 19/096,346

(22) Filed: Mar. 31, 2025

(51) Int. Cl. C08B 37/00

(52) U.S. Cl. CPC C08B 37/0057

(57) ABSTRACT

A method includes receiving longan fruit. The method includes peeling the longan fruit, wherein the peeling of the longan fruit generates peels. The method includes converting the peels into powder. The method includes soaking the powder in an acetate buffer. The method includes generating a solution based on soaking the powder in the acetate buffer. The method includes adding a first amount of sodium hypochlorite to the solution. The method includes heating the solution. The method includes generating a solid from the solution by centrifugation.

### BACKGROUND

Approximately one-third of food is wasted on a global scale, which not only results in a significant loss of valuable resources but also requires considerable efforts and resources for its disposal and treatment. Addressing this issue is crucial for promoting sustainability and efficiency in food management. Moreover, it holds significant potential for various biopolymers that are beneficial in promoting the circular economy. One such food waste is food waste from the longan fruit with no presently effective process for extracting hemicellulose.

### BRIEF DESCRIPTION OF DRAWINGS

FIG. 1 is a diagram of an example flow process;

FIG. 2 is a diagram of a Scanning Electron Microscopy (SEM) analysis; and

FIGS. 3-6 are diagrams of example graphs.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for a process of extracting hemicellulose and further analysis using FTIR, XRD, SEM, and DSC. In embodiments, the SEM analysis showed the presence of intertwined fibrils, typical of hemicellulose, along with some pores that are formed by the removal of other components. In embodiments, the FTIR analysis revealed the presence of glycosidic bonds of xylan and alkane (C—H) groups in hemicellulose, as well as C═C stretching of aromatic compounds that are present in hemicellulose. In embodiments, the XRD spectrum indicated that the extracted hemicellulose is semi-crystalline. The DSC analysis revealed the thermal stability of hemicellulose.

Hemicellulose is a very important constituent of plant cell walls and has a vital role in the production of biofuels and other bioproducts. It is a natural polysaccharide, next to cellulose, and is the second most abundant renewable component of lignocellulosic biomass. It is produced approximately 60 billion tons annually. A hemicellulose derivative is used to obtain materials such as emulsifiers, films, hydrogels, and also fine chemicals: xylitol, ethanol, and furfural, for example, applied in many fields of medicine, nutrition, and energy storage.

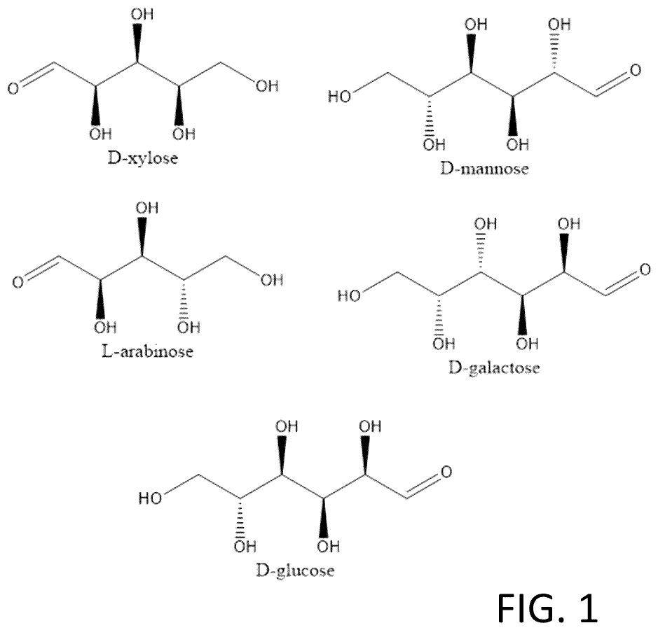

Such polysaccharides are unlimited in availability and present outstanding physical-chemical characteristics. Owing to its extraction from different sources, such as different plants or different plant parts, the hemicelluloses exhibit great variation in the form of different microstructures and molecular compositions. It is a complex, branched heteropolymer of several building block sugars, including pentoses: for example, β-D-xylose and α-L-arabinose and various hexoses, such as β-D-mannose, β-D-glucose, and β-D-galactose, along with glucuronic acid. A smaller proportion of L-rhamnose and L-fucose units is also present within its structure. Among hemicellulose polymers, xylans are the most prevalent. Example composition, chain length, structure, and distribution of side chains in hemicellulose differ depending on the lignocellulosic species are shown in FIG. 1.

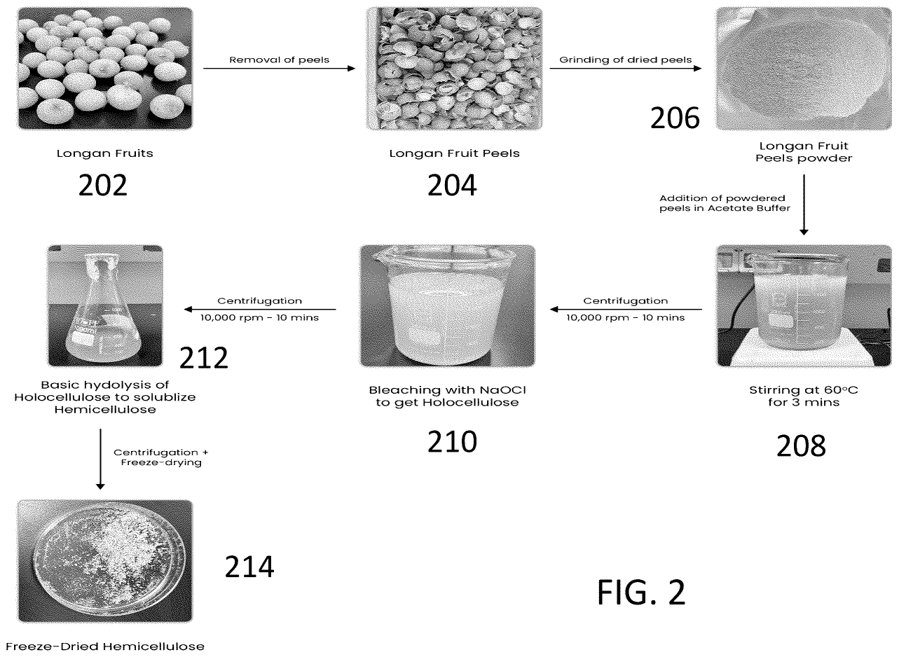

FIG. 2 is an example process for extracting hemicellulose. For the example process, longan fruit is used. In addition, a 5% solution of sodium hypochlorite and 36.46% concentrated Hydrochloric acid is used. In addition, sodium hydroxide (pellets, CAS no. 1310-73-2) and Ethanol absolute (CAS no. 64-17-5) are used. Furthermore, acetic acid (CAS no. 64-19-7) and sodium acetate salt are used.

As shown in FIG. 2, at step 202, longan fruit is received. At step 204, the longan fruit is peeled. At step 206, the peels of longan fruit were converted into fine powder after drying. At step 208, 1.5 L of acetate buffer at pH 4.7 (15 ml of acetic acid and 19.5 g of sodium acetate) is prepared. Then, 25 g of the dried powder is soaked in 1.5 L of acetate buffer at a ratio of 1:60 g/mL solid to liquid, respectively, and subjected to continuous stirring on a magnetic stirrer for three minutes. After three minutes, two-thirds of the solution, around 1 L, is taken out. At step 208, to the 670 mL, two-thirds of one liter, i.e., approximately 670 mL of 4% NaOCl (sodium hypochlorite) solution, is added to aid in bleaching and lignin removal. Then, it was heated at 60° C. with continuous stirring for 3 hours. The holocellulose was then collected by centrifugation at 10,000 rpm for 10 minutes to separate the supernatant. Afterwards, the remaining solid was washed several times with distilled water to remove the residual buffer solution. Finally, it was placed in a drying oven at 40° C. overnight until the sample was completely dry.

The dried holocellulose is then treated at a solid-to-liquid ratio of 1:25 g/mL with 18% NaOH (sodium hydroxide) and stirred at 60° C. for 1 h at 500 rpm using a magnetic stirrer until the hemicellulose dissolved. After the treatment with NaOH, at step 212, the mixture was centrifuged at 10,000 rpm for 10 min to separate and remove the supernatant. The residue was washed several times with distilled water to remove the other remaining NaOH solution. The solid residue was kept in a drying oven at 40° C. overnight to completely dry. The dried filtrate was acidified with 6 M HCL (hydrochloric acid) to a pH of 5.5. After that, it was washed with distilled water several times to remove the HCL. At step 214, the rest of the filtrate was taken for freeze-drying to a fine powder. In embodiments, the dried powder was finally bleached with 50 mL of 5% NaOCl solution to complete the removal of traces of lignin, yielding a whitish color for the hemicellulose. Based on the process described in FIG. 2, 25 g of longan fruit peels, 9.86 g (39.6%) of hemicellulose was extracted.

In embodiments, micrographs are taken using a scanning electron microscope, operated at an accelerating voltage of 20 kV. In embodiments, the extracted hemicellulose is mounted onto aluminum stubs with the assistance of double-sided adhesive tape. Before SEM imaging, the extracted hemicellulose is putter-coated with a thin layer of gold. This is done to enhance the visibility of the surface to enhance the quality of the image taken during scanning.

In embodiments, X-ray diffraction (XRD) analysis of powder samples is carried out. Advanced settings are recorded at 40 kV, the data being measured in a 2-theta (2θ) range between 5 and 55 degrees with a high-resolution step of 0.500 seconds/point. This high-resolution approach is carried out using copper (Kα) radiation with a wavelength of 1.5418 Å, yielding detailed and accurate diffraction patterns for analysis.

In embodiments, chemical interactions of the extracted hemicellulose were studied by means of FTIR spectroscopy. In embodiments, the FTIR spectra is taken with a spectrometer. In embodiments, the Fourier-transform infrared spectroscopy recorded over a broad spectral range that extended from 4000 to 400 cm⁻¹. In order to give a high resolution to these measurements, the step resolution was set at 4 cm⁻¹. This high-resolution method enabled the determination of the exact chemical bonds and interactions in the sample.

In embodiments, the Differential Scanning Calorimetry (DSC) analysis is also conducted. In embodiments, the sample weighing between 5 and 10 mg was accurately sealed in aluminum pans and positioned in the instrument's sample holder. In embodiments, the samples are subsequently heated from 25° C. to 200° C. at a constant rate of 10° C. per minute under a nitrogen atmosphere with a continuous nitrogen purge.

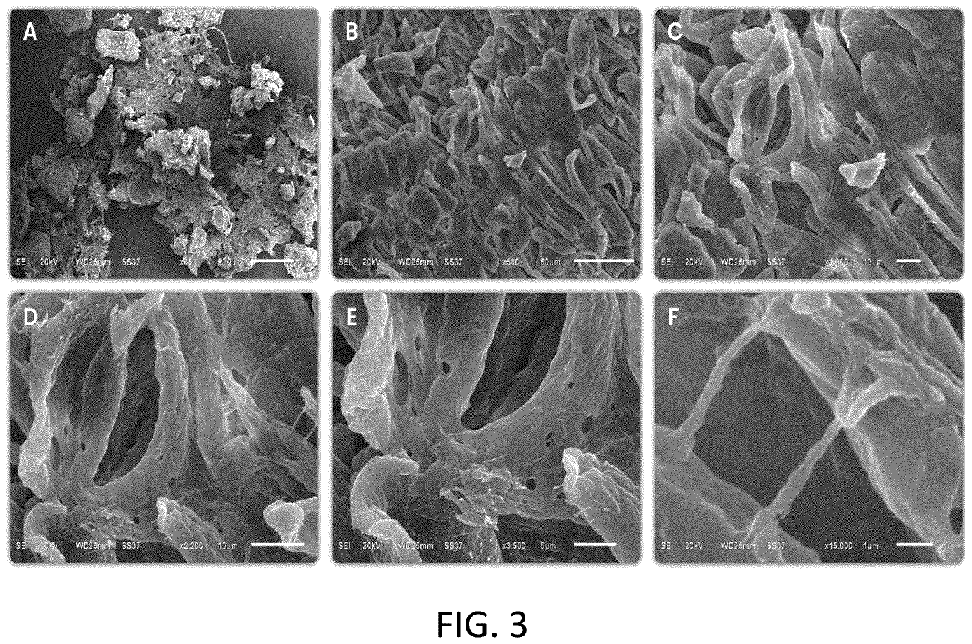

FIG. 3 shows an example SEM analysis of hemicellulose at different magnifications. At the lowest magnification (×35), the extracted hemicellulose shows an irregular, rough, uneven, and fragmented structure with loosely aggregated particles. In embodiments, the magnifications ×500 and ×1,000 revealed layered sheet-like structures that suggest the presence of intertwined fibrils, typical of hemicellulose, with evident porosity. In embodiments, these voids could be due to the removal of other components from plant cell walls, such as lignin. At higher magnifications, ×2,200 and ×3,500, the fine detail networks of hemicellulose are visible. In embodiments, the edges of the fibrils appear to be thin and flexible, indicating the amorphous nature of hemicellulose. The detailed structure of hemicellulose is observed at ×15,000 magnification. A highly porous and web-like fibril network is observed, with nano-bridges connecting different regions. At this magnification, the fibrils appear to be smooth and continuous.

In embodiments, the morphological characteristics, as shown in FIG. 3, indicates that the hemicellulose, even after extraction, retains its fibrous, non-crystalline, and amorphous nature. In embodiments, the fragmentation and porosity in the hemicellulose network could be due to the extraction of other components embedded in the plant cell walls. The observed characteristics, such as high porosity and interconnected fibrils, make the extracted hemicellulose a promising candidate in bio-based materials, particularly for food packaging, biodegradable film formations, and hydrogels.

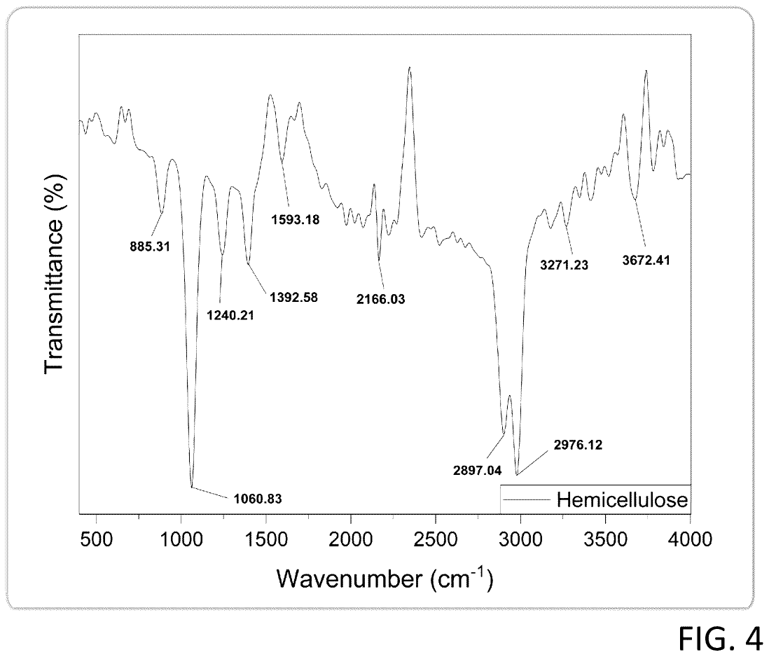

FIG. 4 describes an FTIR spectroscopy of the extracted hemicellulose. In embodiments, the transmittance spectrum recorded reveals several characteristic peaks corresponding to the functional groups found in extracted hemicellulose. In embodiments, the broad peaks observed at 3271 cm⁻¹ and 3672 cm⁻¹ indicate the presence of intermolecular and intramolecular hydroxyl (—OH) groups, which are characteristics of lignin, cellulose, and hemicellulose [30]. As shown in FIG. 4, the peaks around 2897 cm⁻¹ and 2976 cm⁻¹ correspond to the stretching of the alkane (C—H) group that shows the symmetric stretching of methyl and methylene in lignin, cellulose, and hemicellulose. Also, as shown in FIG. 4, the peak absorption at 1392 cm⁻¹ indicates the availability of C—F stretching of fluoro compounds. However, the peak at 1593 cm⁻¹ shows the availability of C═C stretching of the aromatic compound present in hemicellulose.

Moreover, as shown in FIG. 4, the peak at 2166 cm⁻¹ indicates the availability of the S—C═N thiocyanate functional group. The peaks at 1060 cm⁻¹ and 1240 cm⁻¹ represent the C—O stretching of primary alcohol and alkyl ether, which indicates the availability of polysaccharides [31, 33]. The absorption peak at 885 cm⁻¹ corresponds to the vibrational frequency of the C-1 group, indicating the presence of a β-glycosidic bond, which is the primary linkage in xylan.

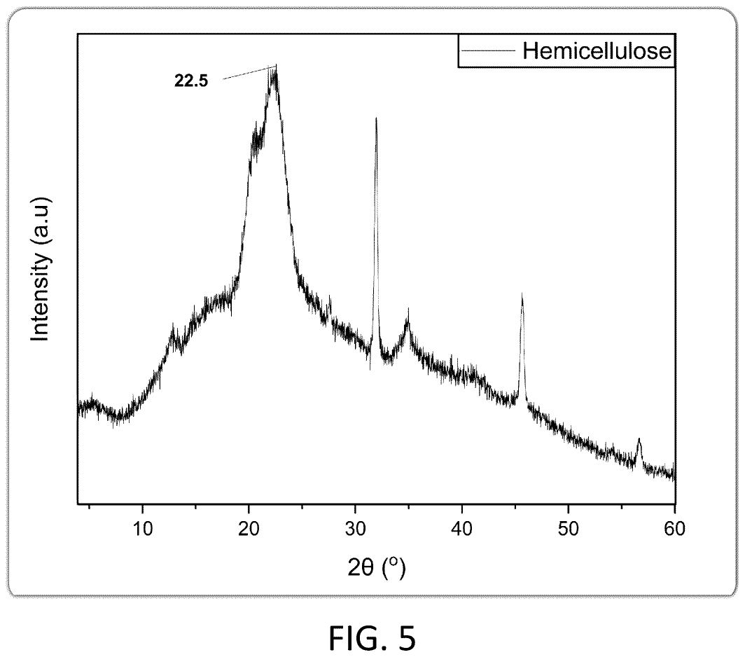

FIG. 5 describes an example graph generated from X-ray diffraction. In embodiments, an X-ray diffraction (XRD) pattern of the extracted hemicellulose shows broad and distinct peaks. In embodiments, the diffraction peak at 22.5° clearly shows ordered regions in the molecular structure of the extracted hemicellulose. This finding underscores its semi-crystalline nature, highlighting the material's unique characteristics and functionality.

In embodiments, the XRD pattern confirms the semi-crystalline nature of hemicellulose, as it lacks the highly ordered crystalline structure compared to cellulose. This semi-crystalline nature of extracted hemicellulose makes it suitable for various applications, such as bio-based material development. Further purification or chemical treatment of the hemicellulose may reduce the intensity of the sharp peaks, enhancing its purity and uniformity. The hemicellulose, unlike cellulose, is well known for its semi-crystalline nature due to its irregular backbone, which is composed of xylan, arabinan, and other sugar units. However, the variation in crystallinity occurs due to various factors, such as the source of extraction or extraction method.

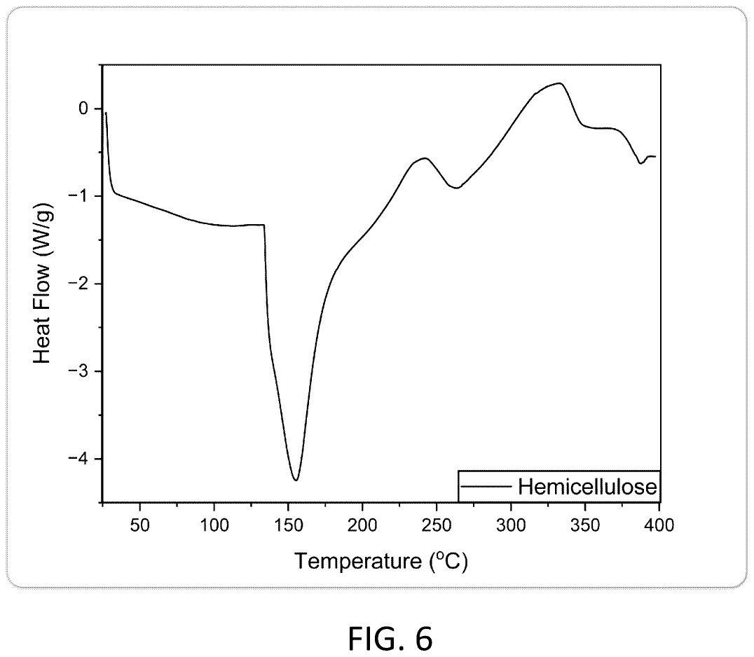

In embodiments, a DSC thermogram of the extracted hemicellulose illustrates the distinct thermal transitions, providing some insights into its thermal properties, as shown in FIG. 6. At the initial stage, the endothermic peak between 50° C. and 150° C. is observed. This peak is attributed to the evaporation of moisture present in the hemicellulose, indicating the presence of moisture bound to the extracted polysaccharide matrix. This could be attributed to the structure of hemicellulose, which contains amorphous hydroxyl groups that readily interact with water molecules from the surrounding atmosphere. The next stage of the endothermic peak was between 150° C. and 250° C., which corresponded to the thermal degradation/depolymerization of extracted hemicellulose.

In embodiments, this degradation/depolymerization is due to the breakdown of glycosidic linkage and the release of volatile compounds from hemicellulose. The exothermic peak lies between 300° C. and 350° C.; during the exothermic stage, the peak appearing is most likely due to the oxidation or further thermal decomposition of the extracted hemicellulose structure. This step could involve the breakdown of residual char after initial degradation. The DSC results indicate that the extracted hemicellulose is hydrophilic in nature due to the loss of moisture at lower temperatures. However, it is thermally stable up to approximately 150° C. This thermal stability is crucial for applications involving thermal processing. However, the variation in DSC occurs due to various factors, such as the source of extraction or extraction method.

Accordingly, for the described process, longan fruit waste was used to extract the hemicellulose by using the modified Vincet's method. In embodiments, these modifications resulted in a significantly improved yield. In embodiments, the SEM analysis of hemicellulose at various magnifications demonstrated that the hemicellulose, even after extraction, retains its fibrous, non-crystalline, and amorphous nature. The void spaces among the fibril network of hemicellulose highlighted the removal of components embedded in plant cell walls during the extraction/purification process. The FTIR analysis revealed the presence of glycosidic bonding and both intermolecular and intramolecular hydroxyl groups, indicating the co-existence of cellulose, lignin, and hemicellulose. The XRD analysis shows that the extracted hemicellulose displayed a semi-crystalline structure, possibly due to the extraction procedure.

For FIG. 2, the order of the blocks may be modified in other implementations. Further, non-dependent blocks may be performed in parallel.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various measurements are provided, such as the weight/quantity of materials used. For each of these measurement quantities, the quantities can range from the specified amount and still be considered to be compliant for the concrete mix described above. For example, the acetate buffer solution used in this process may range from 1.45 to 1.55 L, while the sodium hypochlorite (NaOCl) solution may vary between 640 and 740 mL. The sodium hydroxide (NaOH) concentration might be carefully maintained between 16% and 20%, and the hydrochloric acid (HCl) concentration might be adjusted to between 5.5 and 6.0 M to achieve the desired pH of 5 to 6.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving longan fruit;
peeling the longan fruit, wherein the peeling the longan fruit generates peels;
converting the peels into powder;
soaking the powder in an acetate buffer;
generating a solution based on the soaking the powder in the acetate buffer;
adding a first amount of sodium hypochlorite to the solution;
heating the solution; and
generating a solid from the solution by centrifugation.

2. The method of claim 1, further comprising:
drying the solid.

3. The method of claim 2, further comprising:
acidifying the solid with hydrochloric acid;
washing the solid with water to remove the hydrochloric acid;
freeze-drying the solid; and
bleaching the solid with a second amount of sodium hypochlorite.

4. The method of claim 2, wherein the second amount of sodium hypochlorite is 50 mL of 5% sodium hypochlorite.

5. The method of claim 1, wherein the first amount of sodium hypochlorite is 670 mL of 4% sodium hypochlorite.

6. The method of claim 1, wherein the acetate buffer includes 15ml of acetic acid and 19.5 g of sodium acetate.

7. The method of claim 3, wherein the solid has semi-crystalline characteristics of hemicellulose.
